(19) United States
(12) Patent Application Publication
(10) Pub. No.: US 2013/0010079 A1
(43) Pub. Date: Jan. 10, 2013

(54) CALIBRATION BETWEEN DEPTH AND COLOR SENSORS FOR DEPTH CAMERAS

(75) Inventors: Cha Zhang, Sammamish, WA (US); Zhengyou Zhang, Bellevue, WA (US)

(73) Assignee: MICROSOFT CORPORATION, Redmond, WA (US)

(21) Appl. No.: 13/178,494

(22) Filed: Jul. 8, 2011

(51) Int. Cl. H04N 13/02

(52) U.S. Cl. 348/47; 348/E13.074

(57) ABSTRACT

A system described herein includes a receiver component that receives a first digital image from a color camera, wherein the first digital image comprises a planar object, and a second digital image from a depth sensor, wherein the second digital image comprises the planar object. The system also includes a calibrator component that jointly calibrates the color camera and the depth sensor based at least in part upon the first digital image and the second digital image.

### BACKGROUND

Recently there have been an increasing number of depth sensors that are available at relatively low prices. In an example, a sensor unit that communicates with a video game console includes a depth sensor. In another example, computing devices (desktops, laptops, tablet computing devices) are being manufactured with depth sensors therein. A sensor unit that includes both a color camera as well as a depth sensor can be referred to herein as a depth camera. Depth cameras have created a significant amount of interest in applications such as three-dimensional shape scanning, foreground-background segmentation, facial expression tracking, amongst others.

Depth cameras generate simultaneous streams of color images and depth images. To facilitate the applications discussed above (and other applications that employ color images and depth images), the depth sensor and color camera may be desirably calibrated. More specifically, both the color camera and the depth sensor have their own respective coordinate systems, and how such coordinate systems are aligned with respect to one another may be desirably determined to allow pixels in a color image generated by the color camera to be effectively mapped to pixels in a depth image generated by the depth sensor and vice versa.

Many difficulties exist with respect to calibrating a color camera and depth sensor. For example, color cameras have been calibrated utilizing colored patterns. Colored patterns, however, cannot be analyzed in a depth image, as such image does not include captured colors (e.g., corners of a pattern are often indistinguishable from other surface points in a depth image). Furthermore, although depth discontinuity can be observed in a depth image, boundary points of an object are generally unreliable due to unknown depth reconstruction mechanisms utilized in the depth sensor.

An exemplary approach to calibrate a color camera and depth sensor is to co-center an infrared image with a depth image. This may require, however, external infrared illumination. Additionally, commodity depth cameras typically produce relatively noisy depth images, rendering it difficult to calibrate the depth sensor with the color camera.

### SUMMARY

The following is a brief summary of subject matter that is described in greater detail herein. This summary is not intended to be limiting as to the scope of the claims.

Described herein are various technologies pertaining to jointly calibrating a color camera and a depth sensor based at least in part images of a scene captured by the color camera and the depth sensor, wherein the scene includes a planar object. For instance, the planar object may be a checkerboard. Further, the depth sensor may be any suitable type of depth sensing system, including a triangulation system (such as stereo vision or structured light system), a depth from focus system, a depth from shape system, a depth from motion system, a time of flight system, or other suitable type of depth sensor system.

As will be described in greater detail herein, jointly calibrating the color camera and the depth sensor includes ascertaining a rotation and a translation between coordinate systems of the color camera and the depth sensor, respectively. In connection with computing these values, instructions can be output to a user that instructs the user to move a planar object, such as a checkerboard, to different positions in front of the color camera and the depth sensor. The color camera and the depth sensor may be synchronized, such that an image pair (an image from the color camera and an image from the depth sensor) include the planar object at a particular position and orientation. Rotation and translation between the coordinate systems of the color camera and the depth sensor can be ascertained based at least in part upon a plurality of such image pairs that include the planar object at various positions and orientations.

Two exemplary techniques for ascertaining the rotation and translation between the coordinate systems of the color camera and the depth sensor are described herein. In a first exemplary technique, an image generated by the color camera can be analyzed to locate the known pattern of the planar object has been captured in such image. Because the pattern in the planar object is known, such planar object can be automatically located in the color image, and the three-dimensional orientation and position of the planar object in the color image can be computed relative to the color camera. A corresponding plane may be then fit into a corresponding image generated by the depth sensor. The plane can be fit based at least in part upon depth values in the image generated by the depth sensor. The plane fit in the image generated by the depth sensor corresponds to the observed plane in the color image after application of a rotation and translation to the plane in the depth image. Through such approach the rotation and translation between the coordinate systems of the color camera and the depth sensor can be computed.

In another exemplary approach, rather than fitting a plane into the depth image, a set of points in the depth image can be randomly sampled. A relatively large number of points in the depth image can be sampled, and at least some of such points will correspond to points of the planar object in the color image by way of a desirably computed rotation and translation between coordinate systems of the color camera and the depth sensor. If a sufficient number of points are sampled, a likelihood function can be learned and evaluated to compute the rotation and translation mentioned above.

Other aspects will be appreciated upon reading and understanding the attached Figs. and description.

### BRIEF DESCRIPTION OF THE DRAWINGS

FIG. 1 is a functional block diagram of an exemplary system that facilitates jointly calibrating a color camera and a depth sensor.

FIG. 2 illustrates coordinate systems of the color camera and the depth sensor.

FIG. 3 is a functional block diagram of an exemplary system that facilitates overlaying a color image onto a depth image based at least in part upon a computed rotation and translation between a color camera and a depth sensor.

FIG. 4 is a flow diagram that illustrates an exemplary methodology for automatically jointly calibrating a color camera and a depth sensor.

FIG. 5 is an exemplary computing system.

### DETAILED DESCRIPTION

Various technologies pertaining to jointly calibrating a color camera and a depth sensor will now be described with reference to the drawings, where like reference numerals represent like elements throughout. In addition, several functional block diagrams of exemplary systems are illustrated and described herein for purposes of explanation; however, it is to be understood that functionality that is described as being carried out by certain system components may be performed by multiple components. Similarly, for instance, a component may be configured to perform functionality that is described as being carried out by multiple components. Additionally, as used herein, the term “exemplary” is intended to mean serving as an illustration or example of something, and is not intended to indicate a preference.

As used herein, the terms “component” and “system” are intended to encompass computer-readable data storage that is configured with computer-executable instructions that cause certain functionality to be performed when executed by a processor. The computer-executable instructions may include a routine, a function, or the like. It is also to be understood that a component or system may be localized on a single device or distributed across several devices.

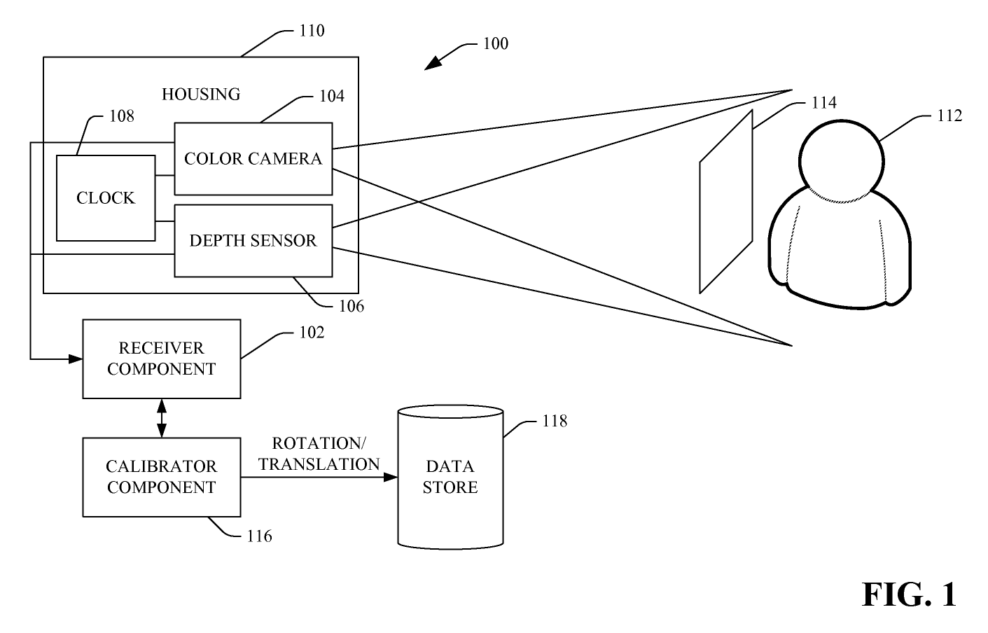

With reference now to FIG. 1, an exemplary system 100 that facilitates jointly calibrating a color camera and depth sensor is illustrated. A combination of a color camera and a depth sensor will be referred to herein as a depth camera. As will be described in greater detail below, jointly calibrating a color camera and a depth sensor may comprise learning a rotation and translation between coordinate systems of the color camera and depth sensor, respectively. The system 100 comprises a receiver component 102 that receives a first digital image from a color camera 104 and a second digital image from a depth sensor 106. In an exemplary embodiment, the first digital image output by the color camera 104 may have a resolution that is the same as the resolution of the second digital image output by the depth sensor 106. Furthermore, the depth sensor 106 may be or include any suitable type of depth sensor system including, but not limited to, a stereo vision or structured light system, a depth from focus system, a depth from shape system, a depth from motion system, a time of flight system, or the like. A clock 108 can be in communication with the color camera 104 and the depth sensor 106, and can assign timestamps to images generated by the color camera 104 and the depth sensor 106, such that images from the color camera 104 and depth sensor 106 that correspond to one another in time can be determined.

In an exemplary embodiment, a housing 110 may comprise the color camera 104, the depth sensor 106, and the clock 108. The housing 110 may be a portion of a sensor that is utilized in connection with a video game console to detect position and motion of a game player. In another exemplary embodiment, the housing 110 may be a portion of a computing system that includes the color camera 104 and the depth sensor 106 for purposes of video-based communications. In still yet another exemplary embodiment, the housing 110 may be for a video camera that is configured to generate three-dimensional video. These embodiments are presented for purposes of explanation and are not intended to limit the scope of the claims. For example, the combination of the color camera 104 and the depth sensor 106 can be utilized in connection with a variety of different types of applications, including three-dimensional shape scanning, foreground-background segmentation, facial expression tracking, three-dimensional image or video generation, amongst others.

Pursuant to an example, the color camera 104 and the depth sensor 106 may be directed at a user 112 that is holding or supporting a planar object 114. In an example, the planar object 114 may be a patterned object such as a game board. For instance, the planar object 114 may be a checkerboard. Moreover, the user 112 can be instructed to move the planar object 114 to a plurality of different locations, and the color camera 104 and the depth sensor 106 can capture images that include the planar object 114 at these various locations.

A calibrator component 116 is in communication with the receiver component 102 and jointly calibrates the color camera 104 and the depth sensor 106 based at least in part upon the first digital image generated by the color camera 104 and the second digital image generated by the depth sensor 106. Pursuant to an example, jointly calibrating the color camera 104 and the depth sensor 106 may comprise computing a rotation and translation between a coordinate system of the color camera 104 and a coordinate system of the depth sensor 106. In other words, the calibrator component 116 can output values that indicate how the color camera 104 is aligned and rotated with respect to the depth sensor 106.

A data store 118 can be accessible to the calibrator component 116, and the calibrator component 116 can cause the rotation and translation to be retained in the data store 118. The data store 118 may be any suitable hardware data store, including a hard drive, memory, or the like. The calibrator component 116 may utilize any suitable technique for jointly calibrating the color camera 104 and the depth sensor 106. In an exemplary embodiment, the calibrator component 116 can have knowledge of the three-dimensional orientation and position of the planar object 114 in the first digital image generated by the color camera 104 based at least in part upon a priori knowledge of the pattern of the planar object 114. As the depth sensor 106 is also directed to capture an image of the planar object 114, the calibrator component 116 can leverage the knowledge of the existence of the planar object 114 in the second digital image generated by the depth sensor 106 to compute the rotation and translation between the coordinate systems of the color camera 104 and the depth sensor 106, respectively. Specifically, the calibrator component 116 can fit a plane that corresponds to the planar object 114 in the image generated by the color camera 104 onto the second digital image generated by the depth sensor 106. Such plane can be fit based at least in part upon three-dimensional points in the second digital image generated by the depth sensor 106. The plane fit onto the image generated by the depth sensor 106 and the plane corresponding to the planar object 114 observed in the first digital image generated by the color camera 104 correspond to one another by the rotation and translation that is desirably computed. The calibrator component 116 can compute such rotation and translation and cause these values to be retained in the data store 118.

In another exemplary embodiment, the calibrator component 116 can randomly sample points in the second digital image generated by the depth sensor 106 that are known to correspond to the planar object 114 in the second digital image. Each randomly sampled point in the image generated by the depth sensor 106 will correspond to a point in the color image that corresponds to the planar object 114. Each point in the image generated by the depth sensor 106 that corresponds to the planar object 114 is related to a point in the image generated by the color camera 104 that corresponds to the planar object 114 by the desirably computed rotation and translation values. If a sufficient number of points are sampled, the calibrator component 116 can compute the values for rotation and translation. Still further, a combination of these approaches can be employed.

Moreover, while the examples provided above have referred to a single image pair (a color image and a depth image), it is to be understood that the calibrator component 116 can consider multiple image pairs with the planar object 114 placed at various different locations and orientations relative to the color camera 104 and the depth sensor 106. For instance, a minimum number of image pairs used by the calibrator component 116 to determine a rotation matrix can be 2, while a minimum number of image pairs used by the calibrator component 116 to determine a translation can be 3. The rotation and translation between the color camera 104 and the depth sensor 106 may then be computed based upon correspondence of the planar object 114 across various color image/depth image pairs.

Further, while the calibrator component 116 has been described above as jointly calibrating the color camera 104 and the depth sensor 106 through analysis of images generated thereby that include the planar object 114, in other exemplary embodiments an object captured in the images need not be entirely planar. For instance, a planar board that includes a plurality of apertures in a pattern can be utilized such that the pattern can be recognized in the first digital image generated by the color camera 104 and the pattern can also be recognized in the second digital image generated by the depth sensor 106. A correspondence between the located patterns in the first digital image and the second digital image may then be employed by the calibrator component 116 to compute the rotation and translation between respective coordinate systems of the color camera 104 and the depth sensor 106.

In yet another exemplary embodiment, the calibrator component 116 can consider point correspondences between the first digital image generated by the color camera 104 and the second digital image generated by the depth sensor 106 in connection with jointly calibrating the color camera 104 and the depth sensor 106. For instance, a user may manually indicate a point in the color image and a point in the depth image, wherein these two points correspond to one another across the images. Additionally or alternatively, image analysis techniques can be employed to automatically locate corresponding points across images generated by the color camera 104 and the depth sensor 106. For instance, the calibrator component 116 can learn a likelihood function that minimizes projected distance between corresponding point pairs across images generated by the color camera 104 and images generated by the depth sensor 106.

In yet another exemplary embodiment, the calibrator component 116 may consider distortion in the depth sensor 106 when jointly calibrating the color camera 104 with the depth sensor 106. For example, depth values generated by the depth sensor 106 may have some distortion associated therewith. A model of such distortion is contemplated and can be utilized by the calibrator component 116 when jointly calibrating the color camera 104 and the depth sensor 106.

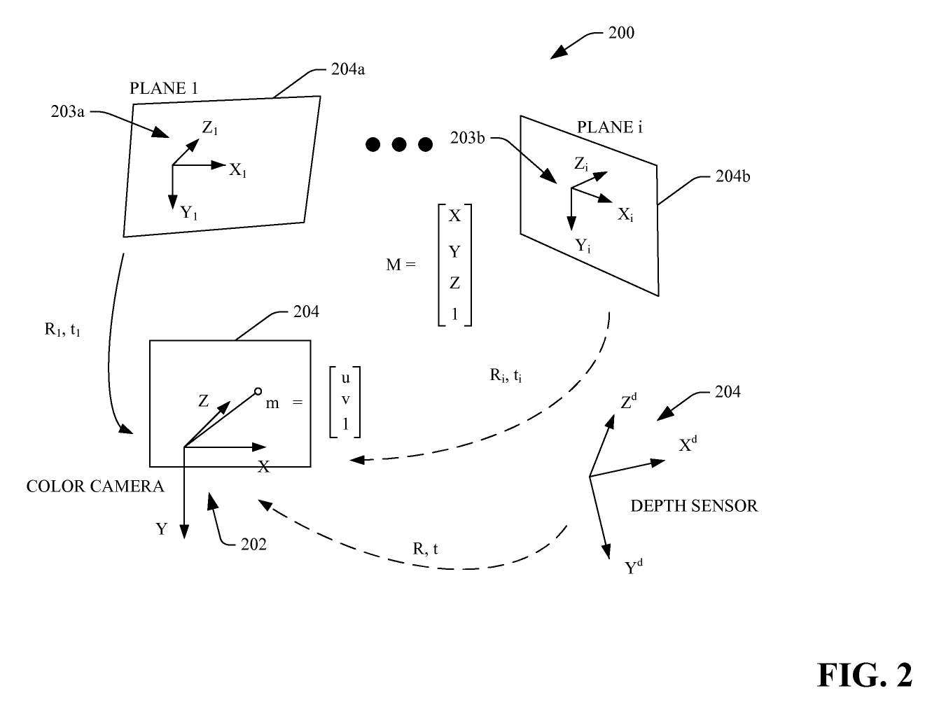

With reference now to FIG. 2, an exemplary illustration 200 of existence of the planar object 114 across a plurality of images and notations used to describe a calibration procedure is shown. For purposes of explanation, a three-dimensional coordinate system 202 of the color camera 104 may coincide with a world coordinate system. In a homogeneous representation, a three-dimensional point in the world coordinate system can be denoted by M=[X, Y, Z, 1]^{T}, and its corresponding two-dimensional projection on a model X, Y plane 204 can be denoted m=[u, v, 1]^{T}. The color camera 104 can be modeled by the following pinhole model:

sm=A[I 0]M (1)

where I is the identity matrix, 0 is the zero vector, and s can be a scale factor. In an exemplary embodiment, s=Z. A is the intrinsic matrix of the color camera 104, which can be given as follows:

$$A = [ \begin{matrix}α & γ & {u}_{0} \\ 0 & β & {v}_{0} \\ 0 & 0 & 1\end{matrix} ] \qquad ( 2 )$$

where α and β are the scale factors in the image coordinate system, (u₀, v₀) are the coordinates of the principal point and γ is the skewness of the two image axes.

The depth sensor 106 has a second coordinate system 204 that is different from the coordinate system 202 of the color camera 104. The depth sensor 106 generally outputs an image with depth values denoted by x=[u, v, z]^{T}, where (u, v) are the pixel coordinates, and z is the depth value. The mapping from x to the point in the three-dimensional coordinate system 204 of the depth sensor 106, M^{d}=[X^{d}, Y^{d}, Z^{d}, 1]¹, is usually known, and is denoted as M^{d}=f(x). The rotation and translation between the color camera 104 and the depth camera or depth sensor 106 is denoted by R and t:

$$M = [ \begin{matrix}R & t \\ {0}^{T} & 1\end{matrix} ] {M}^{d} \qquad ( 3 )$$

As mentioned above, the planar object 114 can be moved in front of the color camera 104 and the depth sensor 106. This can create n image pairs (color and depth) captured by the depth camera (the color camera 104 and the depth sensor 106). As shown, the position of the planar object 114 in the n images will be different. The model plane 204 thus has different positions and orientations relative to the position of the color camera 104. Three-dimensional coordinate systems 203a-203b (Xᵢ, Yᵢ, Zᵢ) can be set up for each position of the model plane 204a and 204b across the images such that the Zᵢ=0 plane coincides with the model plane 204. Additionally, it can be assumed that the model plane 204 has a set of M feature points. In an example, the feature points can be corners of a known pattern in the planar object 114, such as a checkerboard pattern. The feature points can be denoted as Pⱼ, j=1, . . . , m. It can be noted that the three-dimensional coordinates of such feature points in each model plane's local coordinate system are identical. Each feature point's local three-dimensional coordinate is associated with a corresponding world coordinate as follows:

$${M}_{i , j} = [ \begin{matrix}{R}_{i} & {t}_{i} \\ {0}^{T} & 1\end{matrix} ] {P}_{j} , \qquad ( 4 )$$

where Mᵢⱼ is the jth feature point of the ith image in the world coordinate system 202, Rᵢ and tᵢ are the rotation and translation from the ith model plane's local coordinate system 203a to the world coordinate system 202. The feature points are observed in the color image as m_{i,j}, which are associated with M_{i,j} through Eq. (1).

Given the set of feature points Pⱼ and their projections m_{i,j}, it is desirable to recover the intrinsic matrix A, the rotations and translations between the models planes 204a and 204b and the model plane 204 Rᵢ and tᵢ, and the transform between the color camera 104 and the depth sensor 106 R and t. The intrinsic matrix A and the model plane positions Rᵢ and tᵢ (relative to the global coordinate system 202) can be computed through conventional techniques. Images generated by the depth sensor 106 can be used to compute R and t automatically.

As mentioned previously, the calibration solution for only the color camera 104 is known. Due to the use of the pinhole camera model, the following can be acquired:

sᵢⱼmᵢⱼ=A[Rᵢ,tᵢ]Pⱼ. (5)

In practice, feature points on images generated by the color camera 104 are typically extracted automatically through utilization of computer-executable algorithms, and therefore may have errors associated therewith. Accordingly, if it is assumed that M_{i,j} follows a Gaussian distribution with the ground truth position as its mean, e.g.,

mᵢⱼ˜N( m̅ᵢⱼ, Φᵢⱼ), (6)

then the log likelihood function can be written as follows:

$$\begin{matrix}{L}_{1} = - \frac{1}{2 nm} {\sum }_{i = 1}^{n} {\sum }_{j = 1}^{m} {ε}_{ij}^{T} {Φ}_{ij}^{- 1} {ε}_{ij} , \\ where & ( 7 ) \\ {ε}_{ij} = {m}_{ij} - \frac{1}{{s}_{ij}} A [ {R}_{i} {t}_{i} ] {P}_{j} . & ( 8 )\end{matrix}$$

Terms related to images generated by the depth sensor 106 are now discussed. There are a set of points in the image generated by the depth sensor 106 that correspond to the model plane 204. Kᵢ points within the quadrilateral in the depth image can be randomly sampled and denoted by Mᵢₖ_{ᵢ}^{d}, i=1, . . . , n; kᵢ=1, . . . , Kᵢ. If the image generated by the depth sensor 106 (the depth image) is free of noise, the following is obtained:

$${[ 0 \; 0 \; 1 \; 0 ] [ \begin{matrix}{R}_{i} & {t}_{i} \\ {0}^{T} & 1\end{matrix} ]}^{- 1} [ \begin{matrix}R & t \\ {0}^{T} & 1\end{matrix} ] {M}_{{ik}_{i}}^{d} = 0 , \qquad ( 9 )$$

which indicates that if these points are transformed to the local coordinate system of each model plane 204a-204b, the coordinate shall be zero.

Since images generated by the depth sensor 106 tend to be noisy, Mᵢₖ_{ᵢ}^{d} can follow a Gaussian distribution as:

mᵢₖ^{d}˜N( M̅ᵢₖ^{d}, Φᵢₖ_{ᵢ}^{d}), (10)

The log likelihood function can thus be written as follows:

$$\begin{matrix}{L}_{2} = - \frac{1}{2 {\sum }_{i = 1}^{n} {K}_{i}} {\sum }_{i = 1}^{n} {\sum }_{{K}_{i} = 1}^{{K}_{i}} \frac{{ɛ}_{{ik}_{i}}^{2}}{{σ}_{{ik}_{i}}^{2}} , \\ where & ( 11 ) \\ {ɛ}_{{ik}_{i}} = {a}_{i}^{T} {M}_{{ik}_{i}}^{d} , \\ where & ( 12 ) \\ {a}_{i} = [ \begin{matrix}{R}^{T} & 0 \\ {t}^{T} & 1\end{matrix} ] [ \begin{matrix}{R}_{i} & 0 \\ - {t}_{i}^{T} {R}_{i} & 1\end{matrix} ] [ \begin{matrix}0 \\ 0 \\ 1 \\ 0\end{matrix} ] , \\ and & ( 13 ) \\ {σ}_{{ik}_{i}}^{2} = {a}_{i}^{T} {Φ}_{{ik}_{i}}^{d} {a}_{i} . & ( 14 )\end{matrix}$$

As mentioned above, it may be helpful to have a plurality of corresponding point pairs in images generated by the color camera 104 and images generated by the depth sensor 106. Such point pairs can be denoted as (mᵢₚ_{ᵢ}, Mᵢₚ_{ᵢ}^{d}), i=1, . . . , n; pᵢ=1, . . . , Pᵢ. Such point pairs shall satisfy the following:

sᵢₚ_{ᵢ}mᵢₚ_{ᵢ}=A[R t]Mᵢₚ_{ᵢ}^{d}. (15)

Further, whether the point correspondences are manually labeled or automatically established, such point correspondences may not be accurate. According, the following can be assumed:

mᵢₚ_{ᵢ}˜N( m̅ᵢₚ_{ᵢ}, Φᵢₚ_{ᵢ}); Mᵢₚ_{ᵢ}^{d}˜N( M̅ᵢₚ_{ᵢ}^{d}, Φᵢₚ_{ᵢ}^{d}), (16)

where Φᵢₚ_{ᵢ} models the inaccuracy of the point in the image generated by the color camera 104, and Φᵢₚ^{d} models the uncertainty of the three-dimensional point in the image generated by the depth sensor 106. The log likelihood function can then be written as follows:

$$\begin{matrix}{L}_{3} = - \frac{1}{2 {\sum }_{i = 1}^{n} {P}_{i}} {\sum }_{i = 1}^{n} {\sum }_{{p}_{i} = 1}^{{p}_{i}} {ξ}_{{ip}_{i}}^{T} {\tilde{Φ}}_{{ip}_{i}}^{- 1} {ξ}_{{ip}_{i}} , \\ where & ( 17 ) \\ {ξ}_{{ip}_{i}} = {m}_{{ip}_{i}} - {B}_{{ip}_{i}} {M}_{{ip}_{i}}^{d} , \\ where & ( 18 ) \\ {B}_{{ip}_{i}} = \frac{1}{{s}_{{ip}_{i}}} A [ R t ] , \\ and & ( 19 ) \\ {\tilde{Φ}}_{{ip}_{i}} = {Φ}_{{ip}_{i}} + {B}_{{ip}_{i}} {Φ}_{{ip}_{i}}^{d} {B}_{{ip}_{i}}^{T} . & ( 20 )\end{matrix}$$

Combining the above information together, the overall log likelihood can be maximized as follows:

max_{A,R}_{ᵢ}_{,t}_{ᵢ}_{R,t}ρ₁L₁+ρ₂L₂+ρ₃L₃, (21)

where ρᵢ, i=1,2,3 are weighting parameters. This objective function can be classified as a nonlinear least squares problem, which can be solved by the calibrator component 116 using the Levenberg-Marquardt method. The result is the computation of the parameters A, Rᵢ, tᵢR, t.

The above algorithms describe calibration of the color camera 104 and the depth sensor 106 with an assumption of no distortions or noise in either of the color camera 104 or the depth sensor 106. A few other parameters, however, may be desirably estimated during calibration by the calibrator component 116. These parameters can include focus, camera center, and depth mapping function for both the color camera 104 and the depth sensor 106. For instance, the color camera 104 may exhibit lens distortions and thus it may be desirable to estimate such distortions based upon the observed model planes 204a-204b in images generated by the color camera 104. Another set of unknown parameters may be in a depth mapping function. For example, an exemplary structured light-based depth camera may have a depth mapping function as follows:

$$f ( x ) = [ \begin{matrix}( μ z + v ) {{( {A}^{d} )}^{- 1} [ u , v , 1 ]}^{T} \\ 1\end{matrix} ] , \qquad ( 22 )$$

where μ and υ are the scale and bias of the z value, and A^{d} is the intrinsic matrix of the depth sensor 106, which is typically predetermined. The other two parameters μ and υ can be used to model the calibration of the depth sensor 106 due to temperature variation or mechanical vibration, and can be estimated within the same maximum likelihood framework by the calibrator component 116.

The exemplary solution described above pertains to randomly sampling points in the image generated by the depth sensor 106. As discussed, however, the calibrator component 116 can use other approaches as alternatives to the techniques described above or in combination with such techniques. For instance, fitting the model plane 204a-204b onto the corresponding image generated by the depth sensor 106 can be undertaken by the calibrator component 116 in connection with calibrating the color camera 104 with the depth sensor 106. In an exemplary embodiment, this plane fitting can be undertaken during initialization to have a first estimate of unknown parameters. For instance, for the parameters related to the color camera 104, e.g., A, Rᵢ, tᵢ, a known initialization scheme can be adapted. Below, methods that can be utilized by the calibrator component 116 to provide an initial estimation of R and t between the color camera 104 and the depth sensor 106 are discussed. During the discussion below, it is assumed that A, Rᵢ and tᵢ of the color camera 104 are known.

For most commodity depth cameras, the color camera 104 and the depth sensor 106 are positioned relatively proximate to one another. Accordingly, it is relatively simple to automatically identify a set of points in each image generated by the depth sensor 106 that lies on the corresponding model plane 204a-204b. These points can be referred to as Mᵢₖ_{ᵢ}^{d}, i=1, . . . , n; kᵢ=1, . . . , Kᵢ. For a given image i generated by the depth sensor 106, if Kᵢ≧3, it is possible to fit a plane to the points in that image. In other words, given the following:

$${H}_{i} [ \begin{matrix}{n}_{i}^{d} \\ {b}_{i}^{d}\end{matrix} ] = [ \begin{matrix}{( {M}_{i 1}^{d} )}^{T} \\ {( {M}_{i 2}^{d} )}^{T} \\ ⋮ \\ {( {M}_{{ik}_{i}}^{d} )}^{T}\end{matrix} ] [ \begin{matrix}{n}_{i}^{d} \\ {b}_{i}^{d}\end{matrix} ] = 0 , \qquad ( 23 )$$

where nᵢ^{d} is the normal of the model plane in the three-dimensional coordinate system of the depth sensor 106, ∥nᵢ^{d}∥²=1, and bᵢ^{d} is the bias from the origin. ∥nᵢ^{d}∥ and bᵢ^{d} can be found by the calibrator component 116 through least squares fitting.

In the coordinate system of the color camera 104 (the global coordinate system 202), the model plane can also be described by the following plane equation:

$${[ 0 \; 0 \; 1 \; 0 ] [ \begin{matrix}{R}_{i} & {t}_{i} \\ {0}^{T} & 1\end{matrix} ]}^{- 1} M = 0. \qquad ( 24 )$$

Since Rᵢ and tᵢ are known, the plane's normal can be represented as nᵢ, ∥nᵢ∥²=1, and bias from the origin bᵢ.

The rotation matrix R may first be solved. For instance, R can be denoted as follows:

$$R = [ \begin{matrix}{r}_{1}^{T} \\ {r}_{2}^{T} \\ {r}_{3}^{T}\end{matrix} ] . \qquad ( 25 )$$

The following objective function may then be minimized with constraint:

J(R)=Σᵢ₌₁ⁿ∥nᵢ−Rnᵢ^{d}∥+Σⱼ₌₁³λⱼ(rⱼ^{T}rⱼ−1)+2λ₄r₁^{T}r₂+2λ₅r₁^{T}r₃+2λ6r2Tr3. (26)

Such objective function can be solved in closed form as follows:

C=Σᵢ₌₁ⁿnᵢ^{d}nᵢ^{T} (27)

The singular value decomposition of C can be written as:

C=UDV^{T}, (28)

where U and V are orthogonal matrices and D is a diagonal matrix. The rotation matrix is as follows:

R=VU^{T}. (29)

The minimum number of images to determine the rotation matrix R is n=2, provided that the two model planes are not parallel to one another.

For translation, the following relationship can exist:

(nᵢ^{d})^{T}t+bᵢ^{d}=bᵢ. (30)

Accordingly, three non-parallel model planes can determine a unique t. If n>3, t may be solved through least squares fitting.

Another exemplary method that can be used by the calibrator component 116 to estimate the initial rotation R and translation t is through knowledge of a set of point correspondences between images generated by the color camera 104 and images generated by the depth sensor 106. Such point pairs can be denoted as (mᵢₚ_{ᵢ}, Mᵢₚ_{ᵢ}^{d}), i=1, . . . , n; pᵢ=1, . . . , Pᵢ. The following relationship exists:

sᵢₚ_{ᵢ}mᵢₚ_{ᵢ}=A[R t]Mᵢₚ_{ᵢ}^{d}. (31)

It can be noted that the intrinsic matrix A is known. In conventional methods, it has been shown that given three point pairs, there are in general four solutions to the rotation and translation. When one has four or more non-co-planar point pairs, the so-called POSIT algorithm can be used to find initial values of R and t.

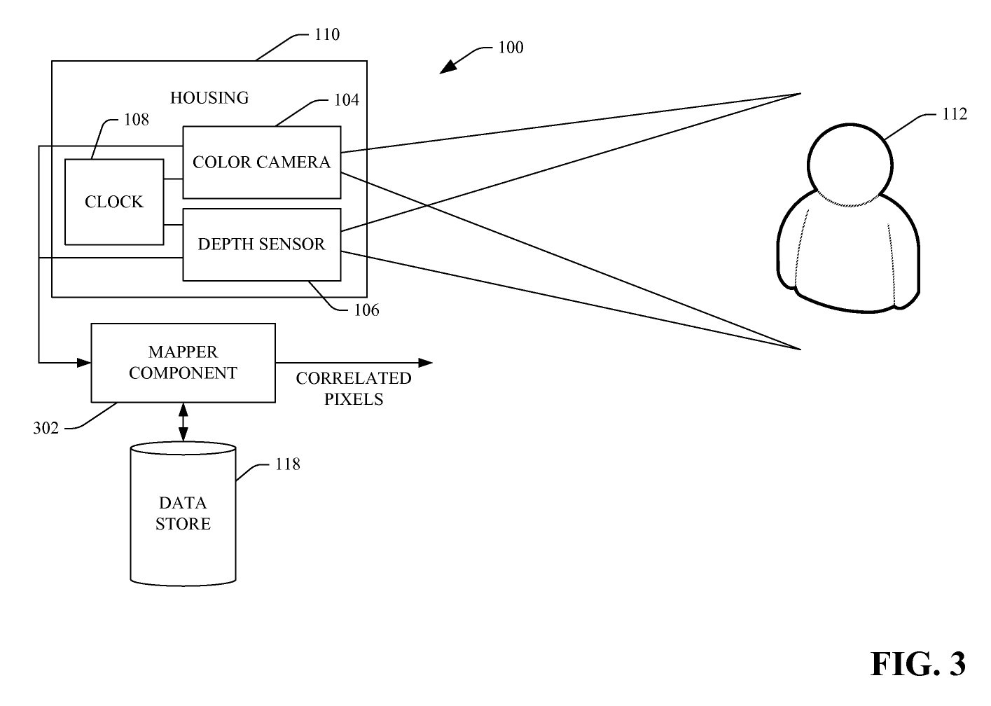

With reference now to FIG. 3, an exemplary system 300 that facilitates applying the computed rotation and translation (computed by the calibrator component 116) to subsequently captured images from the color camera 104 and the depth sensor 106 is illustrated. The system 300 comprises the data store 118, which includes the computed rotation and translation matrices R and t. The system 300 further comprises a mapper component 302 that receives an image pair from the color camera 104 and the depth sensor 106. The mapper component 302 can apply the R and t to the images received from the color camera 104 and/or the depth sensor 106, thereby, for instance, overlaying the color image on the depth image to generate a three-dimensional image. Pursuant to an example, this can be undertaken to generate a three-dimensional video stream.

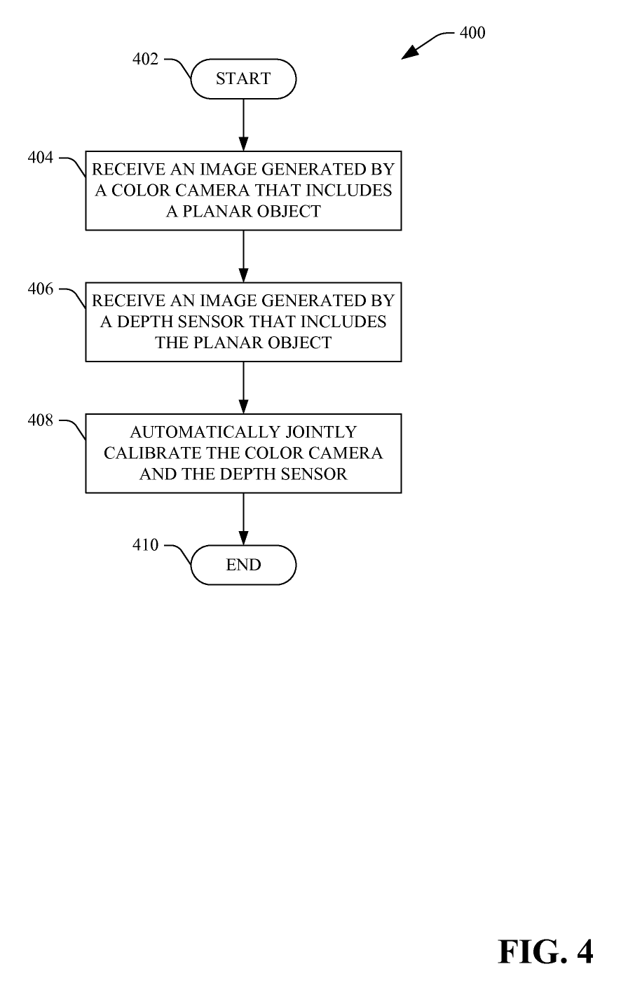

With reference now to FIG. 4, an exemplary methodology 400 is illustrated and described. While the methodology is described as being a series of acts that are performed in a sequence, it is to be understood that the methodology is not limited by the order of the sequence. For instance, some acts may occur in a different order than what is described herein. In addition, an act may occur concurrently with another act. Furthermore, in some instances, not all acts may be required to implement the methodology described herein.

Moreover, the acts described herein may be computer-executable instructions that can be implemented by one or more processors and/or stored on a computer-readable medium or media. The computer-executable instructions may include a routine, a sub-routine, programs, a thread of execution, and/or the like. Still further, results of acts of the methodologies may be stored in a computer-readable medium, displayed on a display device, and/or the like. The computer-readable medium may be any suitable computer-readable storage device, such as memory, hard drive, CD, DVD, flash drive, or the like. As used herein, the term “computer-readable medium” is not intended to encompass a propagated signal.

The exemplary methodology 400 facilitates jointly calibrating a color camera and depth sensor is illustrated. The methodology 400 starts at 402, and at 404 an image generated by a color camera that includes a planar object is received. Prior to receiving the image, an instruction can be output to a user with respect to placement of the planar object relative to the color camera and depth sensor. At 406, a depth image generated by a depth sensor is received, wherein the depth image additionally comprises the planar object. The image generated by the color camera and the image generated by the depth sensor may coincide with one another in time.

At 408, the color camera and the depth sensor are automatically jointly calibrated based at least in part upon the image that comprises the planar object generated by the color camera and the depth image that comprises the planar object generated by the depth sensor. Exemplary techniques for automatically jointly calibrating the color camera in the depth sensor have been described above. Further, while the above has indicated that a single image pair is used, it is to be understood that several image pairs (color images and depth images) can be utilized to jointly calibrate the color camera and depth sensor. The methodology 400 completes at 410.

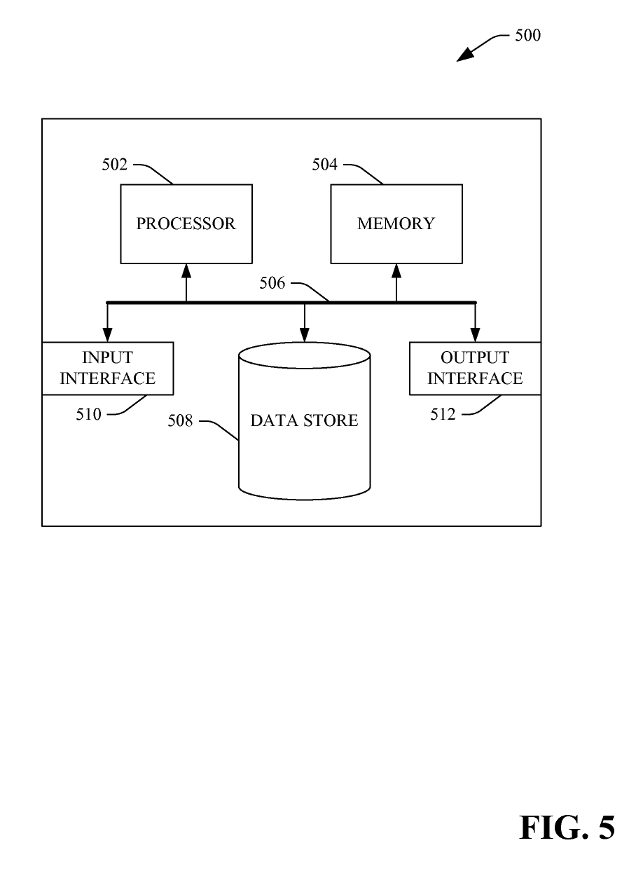

Now referring to FIG. 5, a high-level illustration of an exemplary computing device 500 that can be used in accordance with the systems and methodologies disclosed herein is illustrated. For instance, the computing device 500 may be used in a system that supports jointly calibrating a color camera and a depth sensor in a depth camera. In another example, at least a portion of the computing device 500 may be used in a system that supports modeling noise/distortion of a color camera and/or depth sensor. The computing device 500 includes at least one processor 502 that executes instructions that are stored in a memory 504. The memory 504 may be or include RAM, ROM, EEPROM, Flash memory, or other suitable memory. The instructions may be, for instance, instructions for implementing functionality described as being carried out by one or more components discussed above or instructions for implementing one or more of the methods described above. The processor 502 may access the memory 504 by way of a system bus 506. In addition to storing executable instructions, the memory 504 may also store images (depth and/or color), computed rotation and translation values, etc.

The computing device 500 additionally includes a data store 508 that is accessible by the processor 502 by way of the system bus 506. The data store may be or include any suitable computer-readable storage, including a hard disk, memory, etc. The data store 508 may include executable instructions, images, etc. The computing device 500 also includes an input interface 510 that allows external devices to communicate with the computing device 500. For instance, the input interface 510 may be used to receive instructions from an external computer device, from a user, etc. The computing device 500 also includes an output interface 512 that interfaces the computing device 500 with one or more external devices. For example, the computing device 500 may display text, images, etc. by way of the output interface 512.

Additionally, while illustrated as a single system, it is to be understood that the computing device 500 may be a distributed system. Thus, for instance, several devices may be in communication by way of a network connection and may collectively perform tasks described as being performed by the computing device 500.

It is noted that several examples have been provided for purposes of explanation. These examples are not to be construed as limiting the hereto-appended claims. Additionally, it may be recognized that the examples provided herein may be permutated while still falling under the scope of the claims.

What is claimed is:

1. A method, comprising:
receiving an image generated by a color camera, the image comprising a planar object;
receiving a depth image generated by a depth sensor, the depth image comprising the planar object; and
automatically jointly calibrating the color camera and the depth sensor based at least in part upon the image that comprises the planar object generated by the color camera and the depth image that comprises the planar object generated by the depth sensor.

2. The method of claim 1, wherein the color camera has a first coordinate system and the depth sensor has a second coordinate system, and wherein automatically jointly calibrating the color camera and the depth sensor comprises determining a rotation and translation between the first coordinate system and the second coordinate system.

3. The method of claim 2, wherein automatically jointly calibrating the color camera and the depth sensor comprises calculating a plurality of intrinsic parameters of the color camera and the depth sensor, the plurality of intrinsic parameters comprising a focus, a camera center, and a depth mapping function.

4. The method of claim 1, further comprising:
receiving a first plurality of images that are generated by the color camera over time, each image in the first plurality of images comprising the planar object;
receiving a second plurality of images that are generated by the depth sensor over time, each image in the second plurality of images comprising the planar object, wherein the planar object is at different locations relative to the color camera and the depth sensor in each of the images in the first plurality of images and the second plurality of images; and
automatically jointly calibrating the color camera and the depth sensor based at least in part upon the first plurality of images and the second plurality of images.

5. The method of claim 1, wherein the color camera is a video camera and the depth sensor comprises an infrared camera.

6. The method of claim 1, wherein the depth sensor is one of a time of flight sensor or a structured light sensor.

7. The method of claim 1, wherein the planar object is a checkerboard.

8. The method of claim 1, wherein automatically jointly calibrating the color camera and the depth sensor comprises:
analyzing the image generated by the color camera to ascertain a position and a three-dimensional orientation of the planar object in the image generated by the color camera; and
automatically jointly calibrating the color camera and the depth sensor based at least in part upon the position and the three-dimensional orientation of the planar object in the image generated by the color camera.

9. The method of claim 8, wherein automatically jointly calibrating the color camera and the depth sensor further comprises
fitting a plane on the image generated by the depth sensor; and
learning a translation and rotation between a coordinate system of the depth sensor and a coordinate system of the color camera based at least in part upon an estimated correspondence between the position and three-dimensional orientation of the planar object in the image generated by the color camera and the plane fitted on the image generated by the depth sensor.

10. The method of claim 1, wherein automatically jointly calibrating the color camera and the depth sensor comprises:
sampling pixels in the image generated by the depth sensor that are known to correspond to the planar object; and
learning a likelihood function that is configured to output a likelihood that a particular pixel in the image generated by the depth sensor corresponds to the planar object.

11. The method of claim 10, wherein automatically jointly calibrating the color camera and the depth sensor further comprises learning a translation and rotation between a coordinate system of the depth sensor and a coordinate system of the color camera based at least in part upon an evaluation of the likelihood function.

12. The method of claim 1, further comprising:
subsequent to jointly calibrating the color camera and the depth sensor, receiving a first image from the color camera;
subsequent to jointly calibrating the color camera and the depth sensor, receiving a second image from the color camera; and
overlaying at least a portion of the first image onto the second image to generate a three-dimensional image based at least in part upon the calibrating of the color camera and the depth sensor.

13. A system comprising:
a receiver component that receives:
a first digital image from a color camera, wherein the first digital image comprises a planar object; and
a second digital image from a depth sensor, wherein the second digital image comprises the planar object; and
a calibrator component that jointly calibrates the color camera and the depth sensor based at least in part upon the first digital image and the second digital image.

14. The system of claim 13 comprised by a gaming console.

15. The system of claim 13, wherein the color camera and the depth sensor are included together in a housing.

16. The system of claim 13, wherein the planar object is a checkerboard.

17. The system of claim 13, wherein the calibrator component outputs a rotation and translation between coordinate systems of the color camera and the depth sensor.

18. The system of claim 17, further comprising:
a mapper component that maps pixels of one of an image generated by the color camera or an image generated by the depth sensor to pixels of the other of the image generated by the color camera or the image generated by the depth sensor.

19. The system of claim 18, wherein the mapper component generates a three-dimensional image.

20. A computer-readable data storage medium comprising instructions that, when executed by a processor, cause the processor to perform acts comprising:
outputting at least one instruction to a user with respect to placement of a checkerboard relative to a color camera and a depth sensor;
subsequent to outputting the at least one instruction, causing the color camera to capture a first image that includes the checkerboard;
simultaneously with causing the color camera to capture the image that includes the checkerboard, causing the depth sensor to capture a second image that includes the checkerboard; and
computing an estimated translation and rotation between coordinate systems of the color camera and the depth sensor based at least in part upon the first image and the second image.
